(19) United States
(12) Patent Application Publication
(10) Pub. No.: US 2025/0164292 A1
(43) Pub. Date: May 22, 2025

(54) MONITORING SYSTEM, MONITORING APPARATUS, AND MONITORING METHOD

(71) Applicant: NEC Corporation, Tokyo (JP)

(72) Inventors: June ORIHARA, Tokyo (JP); Masayoshi MACHIDA, Tokyo (JP); Masahiko OHTA, Tokyo (JP); Takuma OKUBO, Tokyo (JP); Masumi SAITOU, Tokyo (JP); Ryusuke IMAI, Tokyo (JP)

(73) Assignee: NEC Corporation, Tokyo (JP)

(21) Appl. No.: 18/931,194

(22) Filed: Oct. 30, 2024

(30) Foreign Application Priority Data
Nov. 20, 2023 (JP) 2023-196479

(51) Int. Cl. G01D 5/353; G06T 7/00

(52) U.S. Cl. CPC G01D 5/35358; G06T 7/0004

(57) ABSTRACT

A monitoring system is provided, including: a data acquisition means for acquiring first data indicating a distribution of at least one physical quantity in a longitudinal direction of an optical fiber calculated based on backscattered light of the optical fiber installed in an infrastructure facility, and second data indicating the at least one physical quantity detected by a measurement sensor installed in the infrastructure facility; a failure detection means for detecting a failure of the infrastructure facility, based on the first data and the second data; and an output means for outputting a detection result by the failure detection means.

### INCORPORATION BY REFERENCE

This application is based upon and claims the benefit of priority from Japanese patent application No. 2023-196479, filed on Nov. 20, 2023, the disclosure of which is incorporated herein in its entirety by reference.

### TECHNICAL FIELD

The present disclosure relates to a monitoring system, a monitoring apparatus, a monitoring method, and a program.

### BACKGROUND ART

Patent Literature 1 (Japanese Unexamined Patent Application Publication No.H01-240828) discloses a technique for measuring a temperature distribution in a longitudinal direction of an optical fiber, based on Raman scattered light generated in the optical fiber by pulsed light.

Patent Literature 2 (Japanese Unexamined Patent Application Publication No.H04-285873) discloses a technique for specifying a temperature distribution of power equipment by providing an optical fiber along the power equipment.

Patent Literature 3 (Japanese Unexamined Patent Application Publication No.2013-148551) discloses a technique for measuring a temperature of a plurality of battery cells by providing an optical fiber along the plurality of battery cells constituting a battery.

### SUMMARY

However, according to the techniques of Patent Literatures 1 to 3 described above, it is not possible to detect a failure of an infrastructure facility with high accuracy.

An example object of the present disclosure is to detect a failure of an infrastructure facility with high accuracy.

In a first example aspect, a monitoring system includes:
a data acquisition means for acquiring first data indicating a distribution of at least one physical quantity in a longitudinal direction of an optical fiber calculated based on backscattered light of the optical fiber installed in an infrastructure facility, and second data indicating the at least one physical quantity detected by a measurement sensor installed in the infrastructure facility;
a failure detection means for detecting a failure of the infrastructure facility, based on the first data and the second data; and
an output means for outputting a detection result by the failure detection means.

In a second example aspect, a monitoring apparatus includes:
a data acquisition means for acquiring first data indicating a distribution of at least one physical quantity in a longitudinal direction of an optical fiber calculated based on backscattered light of the optical fiber installed in an infrastructure facility, and second data indicating the at least one physical quantity detected by a measurement sensor installed in the infrastructure facility;
a failure detection means for detecting a failure of the infrastructure facility, based on the first data and the second data; and
an output means for outputting a detection result by the failure detection means.

In a third example aspect, a monitoring method includes:
acquiring first data indicating a distribution of at least one physical quantity in a longitudinal direction of an optical fiber calculated based on backscattered light of the optical fiber installed in an infrastructure facility, and second data indicating the at least one physical quantity detected by a measurement sensor installed in the infrastructure facility;
detecting a failure of the infrastructure facility, based on the first data and the second data; and
outputting a detection result.

According to the present disclosure, it is possible to detect a failure of an infrastructure facility with high accuracy.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram of a monitoring system;

FIG. 2 is a plan view diagram of an infrastructure system;

FIG. 3 is a data structure diagram of measurement data;

FIG. 4 is a block diagram of an infrastructure facility monitoring apparatus;

FIG. 5 is a control flow of the infrastructure facility monitoring apparatus;

FIG. 6 is a plan view diagram of the infrastructure system;

FIG. 7 is a block diagram of the infrastructure facility monitoring apparatus;

FIG. 8 is a diagram illustrating a case where a processing circuit included in the infrastructure facility monitoring apparatus is configured by a processor and a memory; and

FIG. 9 is a diagram illustrating a case where a processing circuit included in the infrastructure facility monitoring apparatus is configured by dedicated hardware.

### EXAMPLE EMBODIMENT

### Outline of Present Disclosure

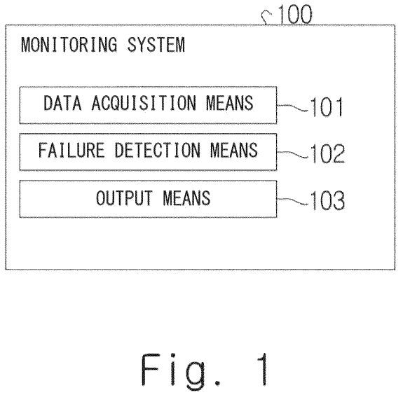

Hereinafter, an outline of the present disclosure will be described. FIG. 1 is a block diagram of a monitoring system 100.

The monitoring system 100 includes a data acquisition means 101, a failure detection means 102, and an output means 103.

The data acquisition means 101 acquires first data indicating a distribution of at least one physical quantity in a longitudinal direction of an optical fiber calculated based on backscattered light of the optical fiber installed in an infrastructure facility, and second data indicating the at least one physical quantity detected by a measurement sensor installed in the infrastructure facility.

The failure detection means 102 detects a failure of the infrastructure facility, based on the first data and the second data.

The output means 103 outputs a detection result by the failure detection means.

According to the above configuration, it is possible to detect a failure of an infrastructure facility with high accuracy.

### First Example Embodiment

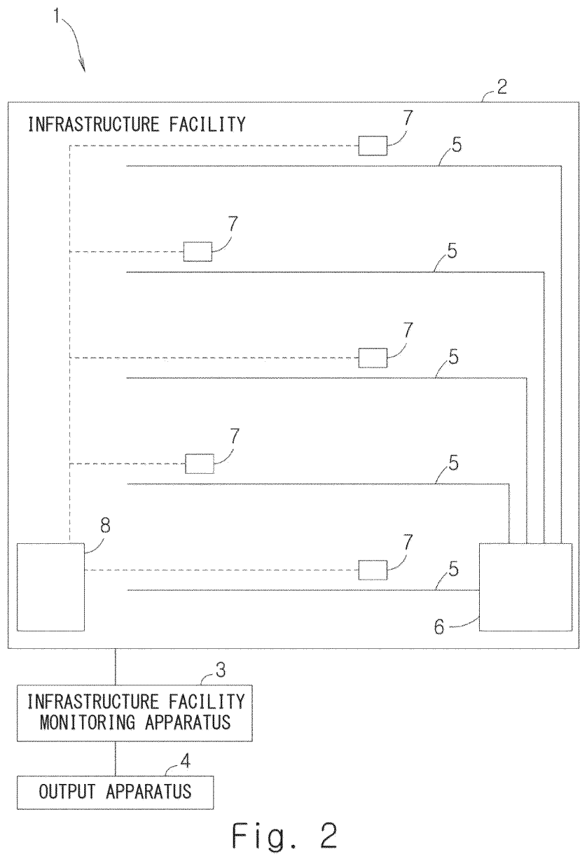

Hereinafter, a first example embodiment of the present disclosure will be described. FIG. 2 is a plan view diagram of an infrastructure system 1. As illustrated in FIG. 2, the infrastructure system 1 includes an infrastructure facility 2, an infrastructure facility monitoring apparatus 3, and an output apparatus 4. The infrastructure facility 2, the infrastructure facility monitoring apparatus 3, and the output apparatus 4 are connected to one another by wire or wireless.

The infrastructure facility 2 is typically a substation, a factory, or a data center.

The infrastructure facility monitoring apparatus 3 is an apparatus that monitors the infrastructure facility 2.

The output apparatus 4 is typically a display or a speaker.

The infrastructure facility 2 is provided with a plurality of optical fibers 5, and an optical fiber sensing apparatus 6. Each of the plurality of optical fibers 5 is provided in such a way as to cover the infrastructure facility 2 in a plan view. Typically, as illustrated in FIG. 2, each of the plurality of optical fibers 5 is provided in such a way as to extend parallel to each other. Alternatively, each of the plurality of optical fibers 5 may be provided in a grid shape. Each of the plurality of optical fibers 5 is connected to the optical fiber sensing apparatus 6. The optical fiber sensing apparatus 6 measures a distribution of a plurality of physical quantities in a longitudinal direction of the optical fiber 5 by emitting pulsed light to each optical fiber 5 and receiving backscattered light thereof.

Each of the plurality of physical quantities is typically vibration, sound, temperature, and distortion. The optical fiber sensing apparatus 6 measures a distribution of vibration in the longitudinal direction of the optical fiber 5, based on the above-described backscattered light. Specifically, the distribution of vibration is a distribution of amplitude of the vibration. The optical fiber sensing apparatus 6 measures a distribution of sound in the longitudinal direction of the optical fiber 5, based on the above-described backscattered light. Specifically, the distribution of sound is a distribution of sound pressure of the sound. The optical fiber sensing apparatus 6 measures a distribution of temperature in the longitudinal direction of the optical fiber 5, based on the above-described backscattered light. The optical fiber sensing apparatus 6 measures a distribution of distortion in the longitudinal direction of the optical fiber 5, based on the above-described backscattered light.

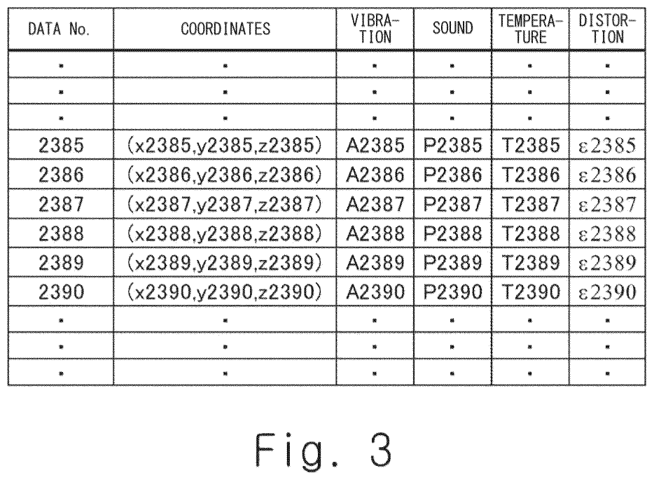

The optical fiber sensing apparatus 6 includes coordinate data indicating arrangement coordinates of the plurality of optical fibers 5. Each optical fiber 5 is arranged in such a way as to extend linearly in a plan view. Therefore, the above-described coordinate data typically include coordinate data of a plurality of points in the longitudinal direction of each optical fiber 5. For example, the above-described coordinate data are configured by coordinate data of 100 points in the longitudinal direction of each optical fiber 5. The optical fiber sensing apparatus 6 generates optical fiber measurement data, based on the coordinate data and an above-described measurement result. The optical fiber measurement data generated by the optical fiber sensing apparatus 6 are one specific example of first data. The optical fiber sensing apparatus 6 outputs the optical fiber measurement data to the infrastructure facility monitoring apparatus 3. FIG. 3 illustrates data structure of the optical fiber measurement data. As illustrated in FIG. 3, the optical fiber measurement data are data in which vibration, sound, temperature, and distortion are associated with coordinates.

The infrastructure facility 2 is further provided with a plurality of measurement sensors 7, and a sensor control apparatus 8.

Each of the plurality of measurement sensors 7 measures a plurality of physical quantities at a specific measurement point of the infrastructure facility 2. Each of the plurality of physical quantities is typically vibration, sound, temperature, and distortion. Each measurement sensor 7 includes a vibration sensor, a sound sensor, a temperature sensor, and a distortion sensor. Each measurement sensor 7 measures a plurality of physical quantities at a measurement point where the measurement sensor 7 is provided. Each measurement sensor 7 outputs a measurement result to the sensor control apparatus 8. In the present example embodiment, each of the plurality of measurement sensors 7 is arranged in a vicinity of each of the plurality of optical fibers 5.

The sensor control apparatus 8 includes coordinate data indicating arrangement coordinates of the plurality of measurement sensors 7. The sensor control apparatus 8 generates sensor measurement data, based on the coordinate data and an above-described measurement result. The sensor measurement data generated by the sensor control apparatus 8 is one specific example of second data. The sensor control apparatus 8 outputs the sensor measurement data to the infrastructure facility monitoring apparatus 3. Data structure of the sensor measurement data is the same as the data structure of the optical fiber measurement data illustrated in FIG. 3.

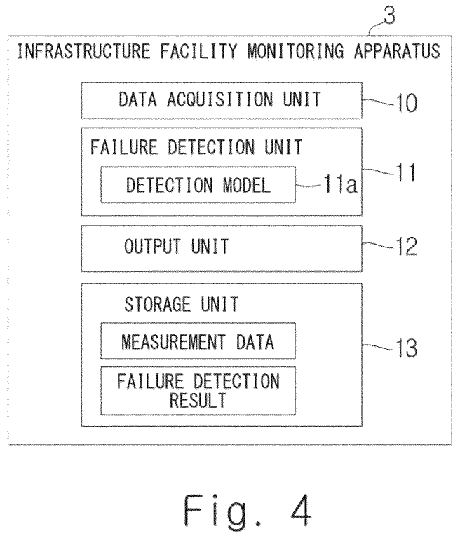

FIG. 4 is a block diagram of the infrastructure facility monitoring apparatus 3. In the present example embodiment, the infrastructure facility monitoring apparatus 3 is achieved by a single apparatus. However, alternatively, the infrastructure facility monitoring apparatus 3 may be achieved by distributed processing by a plurality of apparatuses. The infrastructure facility monitoring apparatus 3 includes a data acquisition unit 10, a failure detection unit 11, an output unit 12, and a storage unit 13.

The data acquisition unit 10 acquires optical fiber measurement data from the optical fiber sensing apparatus 6. The data acquisition unit 10 stores the acquired optical fiber measurement data in the storage unit 13. Similarly, the data acquisition unit 10 acquires sensor measurement data from the sensor control apparatus 8. The data acquisition unit 10 stores the acquired sensor measurement data in the storage unit 13.

The failure detection unit 11 detects a failure of the infrastructure facility 2, based on the optical fiber measurement data and the sensor measurement data stored in the storage unit 13. The failure detection unit 11 stores a failure detection result in the storage unit 13.

Specifically, the failure detection unit 11 determines reliability of the optical fiber measurement data by comparing the optical fiber measurement data with the sensor measurement data. In other words, since the plurality of measurement sensors 7 are respectively arranged in the vicinity of the plurality of optical fibers 5, the sensor measurement data and the optical fiber measurement data are rationally consistent with each other. Further, it is extremely rare that the plurality of optical fibers 5 and the optical fiber sensing apparatus 6, and the plurality of measurement sensors 7 and the sensor control apparatus 8 fail at the same time in a same manner. Therefore, in a case where the optical fiber measurement data and the sensor measurement data are compared with each other, and are rationally consistent with each other, the failure detection unit 11 can be determined that the reliability of the optical fiber measurement data is high.

The failure detection unit 11 includes a detection model 11a. The detection model 11a is typically configured by a neural network learned in such a way as to output a failure of the infrastructure facility 2 when the optical fiber measurement data stored in the storage unit 13 are input. Herein, the failure of the infrastructure facility 2 includes a failure that has already occurred in the infrastructure facility 2, and a failure that may occur in the infrastructure facility 2 in a future. In place of using the detection model 11a, the failure detection unit 11 may detect the above-described failure by comparing a plurality of measurement results constituting the optical fiber measurement data with a threshold value.

The output unit 12 outputs, to the output apparatus 4, a failure detection result by the failure detection unit 11. The output unit 12 may superimpose and output an occurrence position of the failure detected by the failure detection unit 11 on at least one of a map, a power system diagram, and a weather diagram. This allows an operator of the infrastructure facility 2 to easily make a plan of a specific action for the failure.

The output unit 12 may change a display mode of the failure detection result according to a type of a failure. The display mode is typically a color, a shape, or a size of a character or an icon.

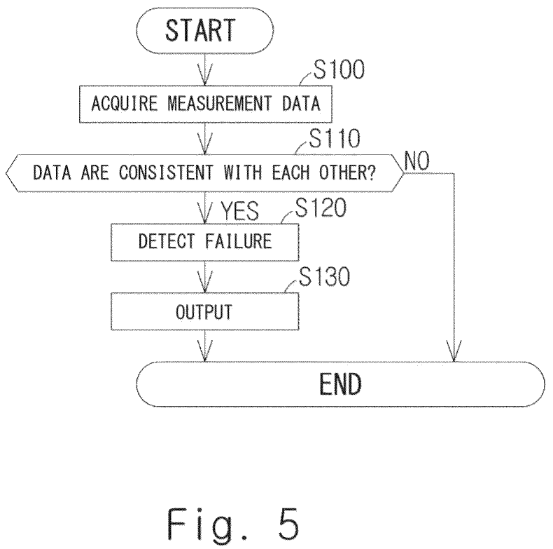

Next, a control flow of the infrastructure facility monitoring apparatus 3 will be described with reference to FIG. 5. FIG. 5 is a control flow of the infrastructure facility monitoring apparatus 3.

First, the data acquisition unit 10 acquires optical fiber measurement data and sensor measurement data (S100). Next, the failure detection unit 11 determines whether the optical fiber measurement data and the sensor measurement data are rationally consistent with each other by comparing the optical fiber measurement data and the sensor measurement data with each other (S110). In a case of NO in step S110, the failure detection unit 11 ends processing. On the other hand, in a case of YES in step S110, the failure detection unit 11 advances processing to step S120. In step S120, the failure detection unit 11 detects a failure of the infrastructure facility 2, based on the optical fiber measurement data (S120). Then, the output unit 12 outputs, to the output apparatus 4, a failure detection result by the failure detection unit 11 (S130).

The first example embodiment of the present disclosure has been described above. The above-described example embodiment includes the following features.

The infrastructure facility monitoring apparatus 3 (monitoring system, monitoring apparatus) includes the data acquisition unit 10 (data acquisition means), the failure detection unit 11 (failure detection means), and the output unit 12 (output means). The data acquisition unit 10 acquires optical fiber measurement data (first data) and sensor measurement data (second data). The optical fiber measurement data are data indicating a distribution of a plurality of physical quantities in the longitudinal direction of the optical fiber 5 calculated based on backscattered light of the optical fiber 5 installed in the infrastructure facility 2. The sensor measurement data are data indicating a plurality of physical quantities detected by the measurement sensor 7 installed in the infrastructure facility 2. The failure detection unit 11 detects a failure of the infrastructure facility 2, based on the optical fiber measurement data and the sensor measurement data acquired by the data acquisition unit 10. The output unit 12 outputs a detection result by the failure detection unit 11. According to the above configuration, it is possible to detect a failure of the infrastructure facility 2 with high accuracy.

In the above-described example embodiment, it has been assumed that the optical fiber measurement data are data indicating a distribution of a plurality of physical quantities in the longitudinal direction of the optical fiber 5 calculated based on backscattered light of the optical fiber 5 installed in the infrastructure facility 2. However, alternatively, the optical fiber measurement data may be data indicating a distribution of at least one physical quantity in the longitudinal direction of the optical fiber 5 calculated based on the backscattered light of the optical fiber 5 installed in the infrastructure facility 2. Similarly, it has been assumed that the sensor measurement data are data indicating a plurality of physical quantities detected by the measurement sensor 7 installed in the infrastructure facility 2. However, alternatively, alternatively, the sensor measurement data may be data indicating at least one physical quantity detected by the measurement sensor 7 installed in the infrastructure facility 2. The at least one physical quantity typically includes any one of vibration, sound, temperature, and distortion.

The physical quantity indicated by the optical fiber measurement data and the physical quantity indicated by the sensor measurement data may be a physical quantity same as each other, or may be a physical quantities different from each other. In a case where both are the same physical quantity, it is easy to determine consistency of both in step S110 in FIG. 5. Even in a case where both are the different physical quantities from each other, for example, in a case where there is a causal relationship or a correlation with each other, such as a case where one of the physical quantity is vibration and the other physical quantity is distortion, it can be said that the consistency of both is easily determined in step S110 in FIG. 5.

Further, the failure detection unit 11 determines reliability of the optical fiber measurement data by comparing the optical fiber measurement data with the sensor measurement data. According to the above configuration, it is possible to ensure the reliability of the optical fiber measurement data with a simple configuration.

Further, a failure detected by the failure detection unit 11 may include a failure occurring in the infrastructure facility 2, and a failure that may occur in the infrastructure facility 2 in the future.

Further, the output unit 12 superimposes and outputs an occurrence position of the failure detected by the failure detection unit 11, and at least one of a map, a power system diagram, and a weather diagram. According to the above configuration, it is easy to make a plan of a specific action for the failure.

Further, the plurality of measurement sensors 7 are arranged in the vicinity of the optical fiber 5. According to the above configuration, it is easy to determine rational consistency between the optical fiber measurement data and the sensor measurement data.

### Second Example Embodiment

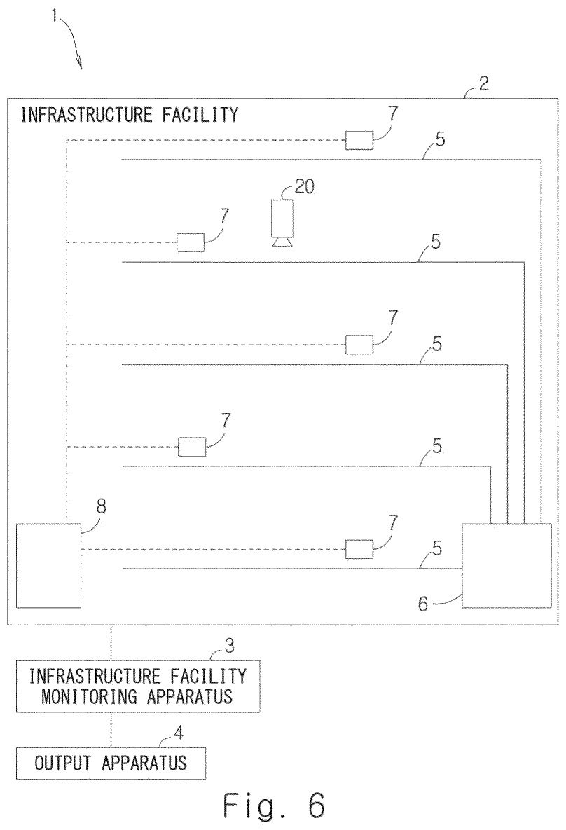

Next, a second example embodiment of the present disclosure will be described. Hereinafter, the present example embodiment will be mainly described in terms of a difference from the above-described first example embodiment, and redundant description will be omitted. FIG. 6 is a plan view diagram of an infrastructure system 1. As illustrated in FIG. 6, an infrastructure facility 2 further includes a monitoring camera 20. The monitoring camera 20 captures an image of the infrastructure facility 2. The monitoring camera 20 outputs a captured image to an infrastructure facility monitoring apparatus 3.

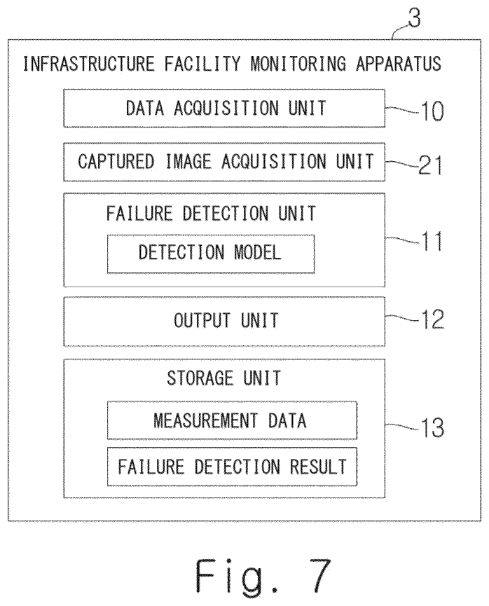

FIG. 7 is a block diagram of the infrastructure facility monitoring apparatus 3. As illustrated in FIG. 7, the infrastructure facility monitoring apparatus 3 includes a captured image acquisition unit 21. The captured image acquisition unit 21 is one specific example of a captured image acquisition means. The captured image acquisition unit 21 acquires a captured image from the monitoring camera 20 at a predetermined interval. The captured image acquisition unit 21 stores the acquired captured image in a storage unit 13.

Then, a failure detection unit 11 detects a failure, based on optical fiber measurement data, sensor measurement data, and a captured image. As one example, the failure detection unit 11 determines reliability of the optical fiber measurement data by comparing the optical fiber measurement data and the sensor measurement data with each other as in the above-described first example embodiment. Then, the failure detection unit 11 detects a failure, based on the optical fiber measurement data and the captured image. Specifically, it is as follows.

The failure detection unit 11 detects deformation in the infrastructure facility 2 by comparing the captured image with a captured image acquired in a past. Deformation of the infrastructure facility 2 typically includes cracking, floating, peeling, flaking, and water leakage of concrete. The failure detection unit 11 may detect deformation in the infrastructure facility 2 by inputting a captured image to a regional convolutional neural network (R-CNN), in place of detecting deformation in the infrastructure facility 2 by the above-described comparison.

Then, the failure detection unit 11 multifacetedly detects a failure of the infrastructure facility 2 by comparing the deformation of the infrastructure facility 2 detected based on the captured image and the optical fiber measurement data with each other.

For example, in a case of detecting a crack in concrete, based on a captured image at a specific position of the infrastructure facility 2, and detecting distortion or vibration of an optical fiber 5 at the specific position, the failure detection unit 11 may determine that a failure has occurred in the infrastructure facility 2 at the specific position.

Similarly, in a case of detecting a crack in concrete, based on a captured image at a specific position of the infrastructure facility 2, but not detecting distortion or vibration of the optical fiber 5 at the specific position, the failure detection unit 11 may determine that a failure has not occurred in the infrastructure facility 2 at the specific position.

Similarly, in a case of not detecting a crack in concrete, based on a captured image at a specific position of the infrastructure facility 2, but detecting distortion or vibration of the optical fiber 5 at the specific position, the failure detection unit 11 may determine that a failure has not occurred in the infrastructure facility 2 at the specific position.

The second example embodiment has been described above. The above-described second example embodiment includes the following features.

The infrastructure facility monitoring apparatus 3 further includes the captured image acquisition unit 21 that acquires a captured image acquired by capturing an image of the infrastructure facility 2. The failure detection unit 11 detects a failure, based on optical fiber measurement data, sensor measurement data, and a captured image. According to the above configuration, it is possible to further improve reliability of failure detection of the infrastructure facility 2.

Although the present disclosure has been described with reference to the example embodiments, the present disclosure is not limited to the above example embodiments. Various changes that can be understood by a person skilled in the art can be made to the configuration and details of the present disclosure within the scope of the present disclosure.

For example, the failure detection unit 11 may acquire weather information such as an occurrence forecast of a lightning strike from a weather server, and predict a failure that may occur in the infrastructure facility 2 in the future, based on the weather information.

Further, the failure detection unit 11 may predict a failure that may occur in the infrastructure facility 2 in the future, based on a location condition of the infrastructure facility 2. Specifically, in a case where a location of the infrastructure facility 2 is close to a coastline, the failure detection unit 11 can predict that salt damage occurs in the infrastructure facility 2.

Further, an output unit 12 may generate countermeasure information indicating a countermeasure associated to a failure detected by the failure detection unit 11. In this case, a form that the output unit 12 may output, to an output apparatus 4, the countermeasure information together with a failure detection result is conceivable.

Subsequently, a hardware configuration of the infrastructure facility monitoring apparatus 3 will be described. In the infrastructure facility monitoring apparatus 3, a data acquisition unit 10, the failure detection unit 11, the output unit 12, and the captured image acquisition unit 21 are achieved by a processing circuit. The storage unit 13 is achieved by a storage circuit. The processing circuit may be a processor that executes a program stored in a memory and the memory, or may be dedicated hardware.

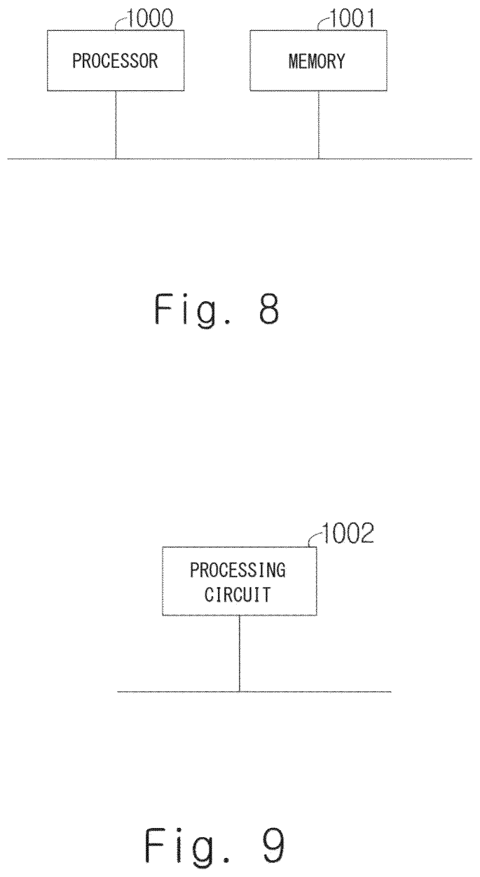

FIG. 8 is a diagram illustrating an example of a case where a processing circuit included in the infrastructure facility monitoring apparatus 3 is configured by a processor and a memory. In a case where the processing circuit is configured by a processor 1000 and a memory 1001, each function of the processing circuit of the infrastructure facility monitoring apparatus 3 is achieved by software, firmware, or a combination of software and firmware. The software or firmware is written as a program and stored in the memory 1001. In the processing circuit, each function is achieved by the processor 1000 reading and executing a program stored in the memory 1001. In other words, the processing circuit includes a memory 1001 for storing a program in which processing of the infrastructure facility monitoring apparatus 3 is to be executed as a result. Further, these programs can also be said to cause a computer to execute a procedure and a method of the infrastructure facility monitoring apparatus 3.

Herein, the processor 1000 may be a central processing unit (CPU), a processing apparatus, an arithmetic operation apparatus, a microprocessor, a microcomputer, a digital signal processor (DSP), or the like. Further, the memory 1001 corresponds to, for example, a non-volatile or volatile semiconductor memory such as a random access memory (RAM), a read only memory (ROM), a flash memory, an erasable programmable ROM (EPROM), or an electrically EPROM (EEPROM), a magnetic disk, a flexible disk, an optical disk, a compact disk, a mini disk, a digital versatile disc (DVD), or the like.

FIG. 9 is a diagram illustrating an example of a case where the processing circuit included in the infrastructure facility monitoring apparatus 3 is configured by dedicated hardware. In a case where the processing circuit is configured by dedicated hardware, a processing circuit 1002 illustrated in FIG. 9 corresponds to, for example, a single circuit, a composite circuit, a programmed processor, a parallel programmed processor, an application specific integrated circuit (ASIC), a field programmable gate array (FPGA), or a combination thereof. Each function of the infrastructure facility monitoring apparatus 3 may be achieved by the processing circuit 1002 by each function, or may be achieved collectively by the processing circuit 1002.

Note that, a part of each function of the infrastructure facility monitoring apparatus 3 may be achieved by dedicated hardware, and a part thereof may be achieved by software or firmware. In this way, the processing circuit can achieve the above each function by dedicated hardware, software, firmware, or a combination thereof.

Each drawing is merely illustrative of one or more example embodiments. Each drawing may be associated with one or more other example embodiments, rather than only one specific example embodiment. As those skilled in the art will appreciate, various features or steps described with reference to any one of the drawings may be combined with features or steps illustrated in one or more other drawings, for example, to generate an example embodiment not explicitly illustrated or described. All of the features or steps illustrated in any one of the drawings to describe the example embodiments are not necessarily essential, and some features or steps may be omitted. The order of the steps described in any of the drawings may be changed as appropriate.

The whole or part of the example embodiments disclosed above can be described as, but not limited to, the following supplementary notes.

### Supplementary Note 1

A monitoring system including:
a data acquisition means for acquiring first data indicating a distribution of at least one physical quantity in a longitudinal direction of an optical fiber calculated based on backscattered light of the optical fiber installed in an infrastructure facility, and second data indicating the at least one physical quantity detected by a measurement sensor installed in the infrastructure facility;
a failure detection means for detecting a failure of the infrastructure facility, based on the first data and the second data; and
an output means for outputting a detection result by the failure detection means.

### Supplementary Note 2

The monitoring system according to supplementary note 1, wherein the failure detection means determines reliability of the first data by comparing the first data with the second data.

### Supplementary Note 3

The monitoring system according to supplementary note 1, wherein the failure detected by the failure detection means includes a failure occurring in the infrastructure facility and a failure that may occur in the infrastructure facility in a future.

### Supplementary Note 4

The monitoring system according to supplementary note 1, further including a captured image acquisition means for acquiring a captured image acquired by capturing an image of the infrastructure facility,
wherein the failure detection means detects the failure, based on the first data, the second data, and the captured image.

### Supplementary Note 5

The monitoring system according to supplementary note 1, wherein the output means superimposes and outputs an occurrence position of the failure detected by the failure detection means, and at least one of a map, a power system diagram, and a weather diagram.

### Supplementary Note 6

The monitoring system according to supplementary note 1, wherein the measurement sensor is arranged in a vicinity of the optical fiber.

### Supplementary Note 7

The monitoring system according to supplementary note 1, wherein the at least one physical quantity includes any one of vibration, sound, temperature, and distortion.

### Supplementary Note 8

A monitoring apparatus including:
a data acquisition means for acquiring first data indicating a distribution of at least one physical quantity in a longitudinal direction of an optical fiber calculated based on backscattered light of the optical fiber installed in an infrastructure facility, and second data indicating the at least one physical quantity detected by a measurement sensor installed in the infrastructure facility;
a failure detection means for detecting a failure of the infrastructure facility, based on the first data and the second data; and
an output means for outputting a detection result by the failure detection means.

### Supplementary Note 9

A monitoring method including:
acquiring first data indicating a distribution of at least one physical quantity in a longitudinal direction of an optical fiber calculated based on backscattered light of the optical fiber installed in an infrastructure facility, and second data indicating the at least one physical quantity detected by a measurement sensor installed in the infrastructure facility;
detecting a failure of the infrastructure facility, based on the first data and the second data; and
outputting a detection result.

### Supplementary Note 10

A program causing a computer to execute the monitoring method according to supplementary note 9.

Some or all of elements (e.g., configurations and functions) described in Supplementary notes 2 to 7 dependent on Supplementary note 1 may be dependent on Supplementary notes 8, 9, and 10 in dependency similar to that of Supplementary notes 2 to 7. Some or all of the elements described in any Supplementary note may be applied to various hardware, software, recording means for recording software, systems, and methods.

A program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The first and second example embodiments can be combined as desirable by one of ordinary skill in the art.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. A monitoring system comprising:
at least one memory storing computer-executable instruction; and
at least one processor configured to access the at least one memory and execute the computer-executable instructions to:
acquire first data indicating a distribution of at least one physical quantity in a longitudinal direction of an optical fiber calculated based on backscattered light of the optical fiber installed in an infrastructure facility, and second data indicating the at least one physical quantity detected by a measurement sensor installed in the infrastructure facility,
detect a failure of the infrastructure facility, based on the first data and the second data, and
output a detection result.

2. The monitoring system according to claim 1, wherein the at least one processor is further configured to execute the instructions to:
determine reliability of the first data by comparing the first data with the second data.

3. The monitoring system according to claim 1, wherein the detected failure includes a failure occurring in the infrastructure facility and a failure that may occur in the infrastructure facility in a future.

4. The monitoring system according to claim 1, wherein the at least one processor is further configured to execute the instructions to:
acquire a captured image acquired by capturing an image of the infrastructure facility, and
detect the failure, based on the first data, the second data, and the captured image.

5. The monitoring system according to claim 1, wherein the at least one processor is further configured to execute the instructions to:
superimpose and output an occurrence position of the detected failure, and at least one of a map, a power system diagram, and a weather diagram.

6. The monitoring system according to claim 1, wherein the measurement sensor is arranged in a vicinity of the optical fiber.

7. The monitoring system according to claim 1, wherein the at least one physical quantity includes any one of vibration, sound, temperature, and distortion.

8. A monitoring apparatus comprising:
at least one memory storing computer-executable instructions; and
at least one processor configured to access the at least one memory and execute the computer-executable instructions to:
acquire first data indicating a distribution of at least one physical quantity in a longitudinal direction of an optical fiber calculated based on backscattered light of the optical fiber installed in an infrastructure facility, and second data indicating the at least one physical quantity detected by a measurement sensor installed in the infrastructure facility,
detect a failure of the infrastructure facility, based on the first data and the second data, and
output a detection result.

9. A computer-implemented monitoring method being performed by at least one processor executing stored instructions to perform steps comprising:
acquiring first data indicating a distribution of at least one physical quantity in a longitudinal direction of an optical fiber calculated based on backscattered light of the optical fiber installed in an infrastructure facility, and second data indicating the at least one physical quantity detected by a measurement sensor installed in the infrastructure facility,
detecting a failure of the infrastructure facility, based on the first data and the second data, and
outputting a detection result.

10. A non-transitory computer-readable storage medium storing a program for causing a computer to execute the computer-implemented monitoring method according to claim 9.
